(19) United States
(12) Patent Application Publication
(10) Pub. No.: US 2024/0375009 A1
(43) Pub. Date: Nov. 14, 2024

(54) SYSTEM AND METHOD FOR CONDUCTING A VIRTUAL RACE EVENT BASED ON REAL-WORLD ACTIVITY USING A SPLIT SCREEN GRAPHICAL USER INTERFACE

(71) Applicant: Lena Faber, Inc., Los Gatos, CA (US)

(72) Inventor: Lena Faber, Los Gatos, CA (US)

(21) Appl. No.: 18/435,921

(22) Filed: Feb. 7, 2024

Related U.S. Application Data
(60) Provisional application No. 63/502,004, filed on May 12, 2023.
(60) Provisional application No. 63/618,371, filed on Jan. 7, 2024.

(51) Int. Cl. A63F 13/65; A63F 13/33

(52) U.S. Cl. CPC A63F 13/65; A63F 13/33

(57) ABSTRACT

Systems and methods for remote participation in athletic competition are disclosed herein. Embodiments of the present invention can enable competition in real-world competitions based on physical activity (e.g., running) that takes place at another physical location. A participants' distance, time, speed, etc., can be tracked, stored, and compared with other participants to determine a winner of the competition, and the participants race placement can be recorded and presented to the competitors. Moreover, according to some embodiments, track conditions and current weather conditions in the field can be compared to the conditions of an actual real-world event to help determine race outcomes and runner position information. Advantageously, the runner's real-world location and the computed position of the runner in the virtual race can be displayed in real-time using a split-screen graphical user interface that seamlessly integrates the runner's real-world activity with the remote competition.

### CROSS-REFERENCE TO RELATED APPLICATIONS

This application claims the benefit of and priority to U.S. Provisional Patent Ser. No. 63/502,004 having the title “SWIM-BALLET CROSS-FIT MACHINE,” filed May 12, 2023, and to U.S. Provisional Patent Ser. No. 63/618,371 having the title “RACE MATCH SYSTEM,” filed Jan. 7, 2024, the entirety of which are hereby incorporated by reference as if set forth fully below. This application is also related to copending U.S. patent application Ser. No. 18/232,158 having title SYSTEM AND METHOD FOR CONDUCTING A REMOTE ATHLETIC COMPETITION BASED ON REAL-WORLD CONDITIONS, filed Aug. 9, 2023, the entire content of which is hereby incorporated by reference as if set forth fully below.

### FIELD

Embodiments of the present invention generally relate to the field of electronic devices for athletic competition. More specifically, embodiments of the present invention relate to systems and methods for competing in or simulating athletic events remotely.

### BACKGROUND

Remote participation is a growing interest in the field of athletic equipment, exercise equipment, and the like, with more and more workers remaining in their homes and seeking an alternative to gyms, which often require additional travel, inconvenience, and expenses. In the case of live, in person athletic competitions, many athletes are unable to travel long distances at the date and time required to participate. Current approaches to organizing races and other athletic competition are unable to seamlessly integrate real-world and virtual components, hindering the creation of global hybrid races. Accordingly, what is needed is an approach to remote participation in athletic competitions that enables participants to compete in events remotely using a specialized graphical user interface to seamlessly coordinate the experience.

### SUMMARY

Systems and methods for remote participation in athletic competition are disclosed herein. Embodiments of the present invention can enable competition in real-world competitions based on physical activity (e.g., running) that takes place at another physical location. A participants' distance, time, speed, etc., can be tracked, stored, and compared with other participants to determine a winner of the competition, and the participants race placement can be recorded and presented to the competitors. Moreover, according to some embodiments, track conditions and current weather conditions in the field can be compared to the conditions of an actual real-world event to help determine race outcomes and runner position information. Advantageously, the runner's real-world location and the computed position of the runner in the virtual race can be displayed in real-time using a split-screen graphical user interface that seamlessly integrates the runner's real-world activity with the remote competition.

The disclosed remote race participation system allows racers to visually position themselves in their physical location while simultaneously appearing in a virtual representation at a designated target location anywhere in the world. The technology supports the concurrent participation of racers in two or more distinct races, offering a versatile and dynamic racing experience. Furthermore, the system extends its utility to Games and Fantasy Sports, providing a flexible environment for the creation and execution of virtual athletic competitions. Moreover, multiple maps can be displayed to provide a split view on single or multiple screens. This unique approach allows racers to visually position themselves in their physical location while simultaneously appearing in a virtual representation at a designated target location anywhere across the globe.

The embodiments disclosed herein can also facilitate the creation of global hybrid athletic races, referred to as “race matches,” which seamlessly blend virtual and real-world experiences. These features enable participants to engage in renowned races (e.g., marathons) or fun runs, walks, and cycling competitions from their physical location while progressing along the target venue anywhere in the world. Furthermore, embodiments can support concurrent participation in multiple distinct races, offering a versatile and dynamic racing experience. For example, athletes can engage in competitive races against each other without needing to physically travel to the same location, which advantageously fosters a global community and ecosystem of virtual competitors.

According to one embodiment, a wireless device for conducting a remote athletic competition is disclosed. The wireless device includes a processor, a display device communicatively coupled to the processor and operable to render a split-screen graphical user interface (GUI), a wireless communication interface communicatively coupled to the processor operable to communicate with a remote server, and a location sensor communicatively coupled to the processor. The location sensor is operable to determine current location data of a remote participant of the remote athletic competition, and the processor is operable to determine an estimated position corresponding to the remote athletic competition based on the current location data The current location data of a remote participant and the estimated position corresponding to the remote athletic competition are both displayed on the split screen GUI.

According to some embodiments, the split-screen GUI includes a first region that displays a map of the remote participant's actual location, and a second region that displays a map of the remote athletic competition.

According to some embodiments, the map of the remote participant's actual location includes a path physically traversed by the remote participant.

According to some embodiments, the map of the remote athletic competition includes an estimated path traversed by the remote participant.

According to some embodiments, the estimated path traversed by the remote participant is computed by the processor based on at least one of: a number of steps taken by the remote participant, the distance traversed by the remote participant, and the speed of the remote participant.

According to some embodiments, the first region and the second region are displayed side-by-side in a horizontal configuration.

According to some embodiments, the first region and the second region are displayed in a vertical configuration.

According to some embodiments, a location of a pacer can be displayed on the split-screen GUI.

According to some embodiments, the processor is operable to adjust the estimated position corresponding to the remote athletic competition based on at least one of: weather data, and topography data.

According to another embodiment, a method of conducting a remote athletic competition in real-time based on a remote athletic competition is disclosed. The method includes determining a runner's real-world location, transmitting the runner's real-world location to a remote server, the remote server translating the runner's real-world location to an estimated location corresponding to a remote athletic competition, receiving the estimated location from the remote server, and displaying the runner's real-world location and the estimated location in real-time on a split-screen graphical user interface (GUI).

According to some embodiments, the runner's real-world location and the estimated location are continuously updated during the remote athletic competition.

According to some embodiments, the method includes displaying race metrics of the runner on the split-screen GUI, and the race metrics include at least one of: overall distance, distance to next checkpoint, steps, and speed.

According to some embodiments, the method includes displaying pace information on the split-screen GUI.

According to some embodiments, the method includes selecting another participant as a pacer and displaying a location of the pacer on the split-screen GUI.

According to a different embodiment, a method of conducting a remote athletic competition in real-time based on a real-world athletic competition is disclosed. The method includes verifying an identity of a remote participant, recording a start time of the remote athletic competition, where the start time of the remote athletic competition is substantially equal to a start time of the real-world athletic competition, mapping a location of the remote participant to an estimated location at the location of the remote athletic competition, and displaying the location of the remote participant and the estimated location at the location of the remote athletic competition simultaneously and in real-time using a split-screen graphical user interface.

According to some embodiments, the method includes accessing real-world athletic competition data.

According to some embodiments, the method includes determining placement information of the remote participant based on the real-world athletic competition data.

According to some embodiments, the method includes the remote participant selecting another participant as a pacer, and displaying the location of another participant on the split-screen GUI.

According to some embodiments, the method includes the remote participant selecting a pace time value, and displaying a pace location on the split-screen GUI based on the pace time value.

According to some embodiments, the method includes displaying race metrics of the remote participant on the split-screen GUI. The race metrics include at least one of: overall distance, distance to next checkpoint, steps, and speed.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts an exemplary real-time athletic competition system for participating in athletic competitions remotely based on real-world race conditions according to embodiments of the present invention.

FIG. 2 is a data transmission diagram depicting exemplary transmissions over a network between a smartphone and a remote server for initiating a virtual race conducted based on real-world event conditions according to embodiments of the present invention.

FIG. 3 is a data transmission diagram depicting exemplary transmissions over a network between a smartphone and a remote server over a computer network for adjusting race metrics based on real-world event conditions to determine race position and/or race placement information of a virtual race according to embodiments of the present invention.

FIG. 4 is a flowchart depicting an exemplary series of computer implemented steps of a process for conducting a remote athletic competition based on real-time conditions of an in-person event, such as a marathon or other race, according to embodiments of the present invention.

FIG. 5 is a flowchart depicting an exemplary series of computer implemented steps of a process for adjusting raw race metrics based on real-world conditions of an in-person race and displaying computed race position and/or placement information in real-time using a split screen graphical user interface according to embodiments of the present invention.

FIG. 6 is a screenshot of a split-screen graphical user interface configured in a landscape orientation for displaying the computed location of a runner competing in a virtual race alongside the real-world location of the runner according to embodiments of the present invention.

FIG. 7 is a screenshot of a split-screen graphical user interface configured in a vertical orientation for displaying the computed path and position of a runner competing in a virtual race alongside the real-world path and position of the runner according to embodiments of the present invention.

FIG. 8 depicts an exemplary computer system (e.g., smartphone) for capturing race metrics and displaying a runner's position and/or placement in a virtual race using a split screen graphical user interface according to embodiments of the present invention.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

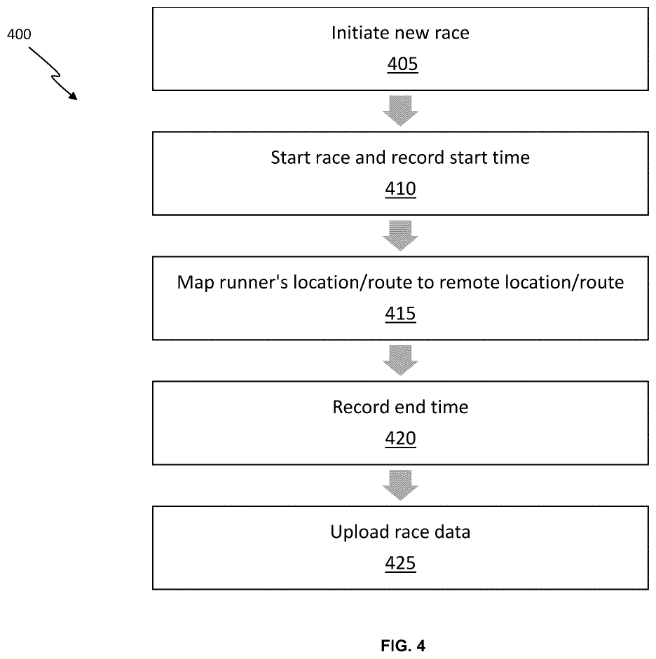

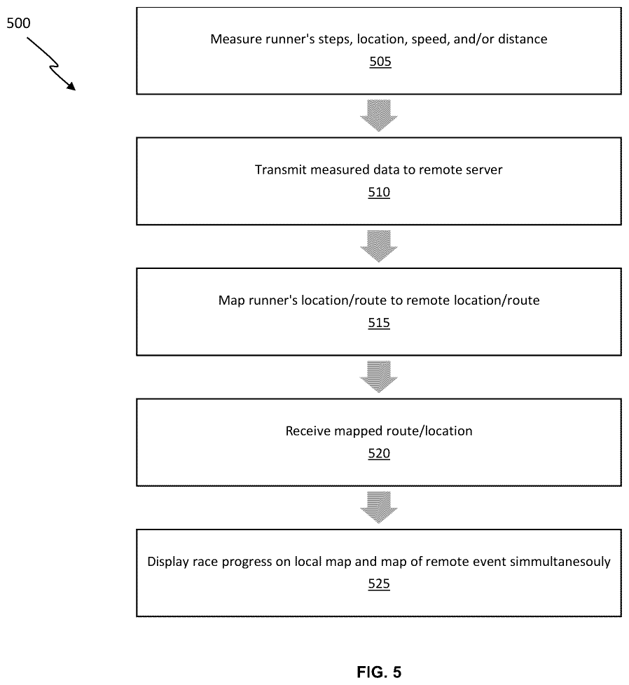

Portions of the detailed description that follows are presented and discussed in terms of a method. Although steps and sequencing thereof are disclosed in a figure herein (e.g., FIGS. 4-5) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “traversing,” “associating,” “identifying,” “updating,” “determining,” “selecting,” “animating,” “displaying,” “lighting” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Remote Race Based on Real-World Activity with Split Screen Interface

Systems and methods for remote participation in athletic competition are disclosed herein. Embodiments of the present invention can enable competition in real-world competitions based on physical activity (e.g., running) that takes place at another physical location. A participants' distance, time, speed, etc., can be tracked, stored, and compared with other participants to determine a winner of the competition, and the participants race placement can be recorded and presented to the competitors. Moreover, according to some embodiments, track conditions and current weather conditions in the field can be compared to the conditions of an actual real-world event to help determine race outcomes and runner position information. Advantageously, the runner's real-world location and the computed position of the runner in the virtual race can be displayed in real-time using a split-screen graphical user interface that seamlessly integrates the runner's real-world activity with the remote competition.

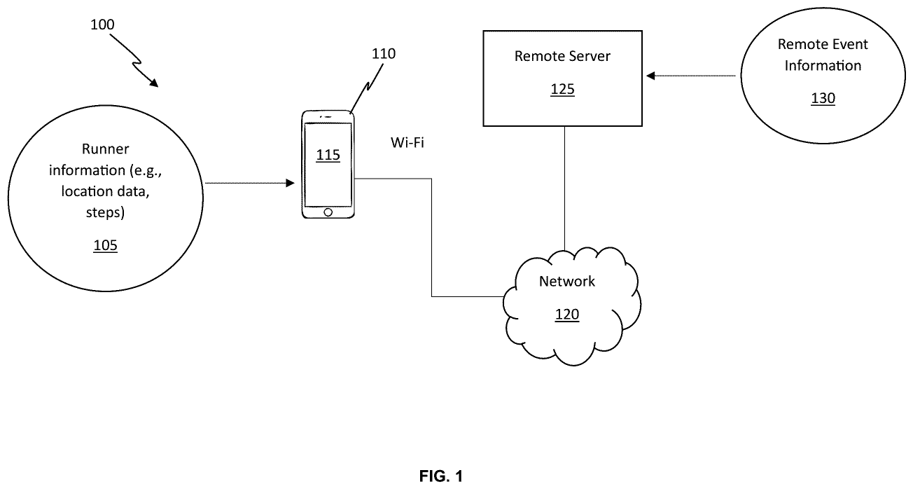

FIG. 1 depicts an exemplary real-time athletic competition system 100 for participating in athletic competitions remotely based on real-world race conditions according to embodiments of the present invention. Smartphone 110 is carried or worn by a runner participating in a virtual race event and includes a display screen 115 that displays a graphical user interface for displaying real-time race information. Smartphone can be any other mobile electronic device (e.g., a wearable electronic device) suitable for use during athletic competition.

According to embodiments, the graphical user interface can be configured in a split-screen view that simultaneously displays a map of the runner's real-world location alongside a computed or estimated position at a corresponding remote race or other athletic competition (e.g., a marathon, sprint, biathlon, triathlon, cycling competition, etc.). The athletic competition can include any form of physical activity based on motion, traveling distances, performing actions/repetitions, etc. For example, the number of steps of a runner can be tracked, as well as distance covered while swimming, walking, etc., determine a real-world location data. Based on the competitor's captured real-world race information (e.g., speed, distance, time, location, path, etc.), virtual race information (e.g., a virtual location) is computed and displayed to the competitor (“runner”) in real-time. For example, remote server 125 can determine that the runner has traversed 3 miles in the real-world and can translate that distance to a route that is approximately the same distance at the remote location. According to some embodiments, the approximated distance at the remote location is adjusted based on conditions e.g., field conditions and event conditions, at the remote location and/or at the runner's physical location.

Runner information 105 is determined by smartphone 110 which is in communication with remote server 125 over a computer network (e.g., the Internet) 120. For example, according to some embodiments, runner information 105 include the runner's path and position recorded during the race, which can include accessing GPS data or terrestrial cell tower information to access or compute location data, speed data, path data, etc. The runner's speed and distance covered can be analyzed by remote server 125 to determine the runner's path and location at the remote event, and the runner's metrics can be adjusted based on the remote event information 130 at the real-world competition (e.g., weather data, topography information, field conditions, etc.) Based on the field runner information 105 and/or the remote race information 130, remote server 125 can determine the runner's estimated position and placement in the remote real-world event, which can be displayed in real-time on a split screen GUI rendered on display screen 115 of smartphone 110 and updated throughout the competition. Remote event information 130 can also include the name of the remote event, the names of event participants, the starting and ending locations of the remote event, previous event times, current event records, a map or path of the event, real-time weather data, etc.

According to some embodiments, smartphone 110 connects to a piece of athletic equipment, such as an exercise bike, rowing machine, etc., to determine the participant's speed and/or distance traveled, which is communicated to remote server 125 and used to determine the participant's placement/location in the corresponding remote athletic competition. The participant's determined placement/location can then be displayed on a map rendered on a graphical user interface.

According to some embodiments, smartphone 110 is a simple device, such as an RFID, NFC, Apple AirTag, etc., that can be used to track and transmit location data for purposes of conducting a remote athletic competition.

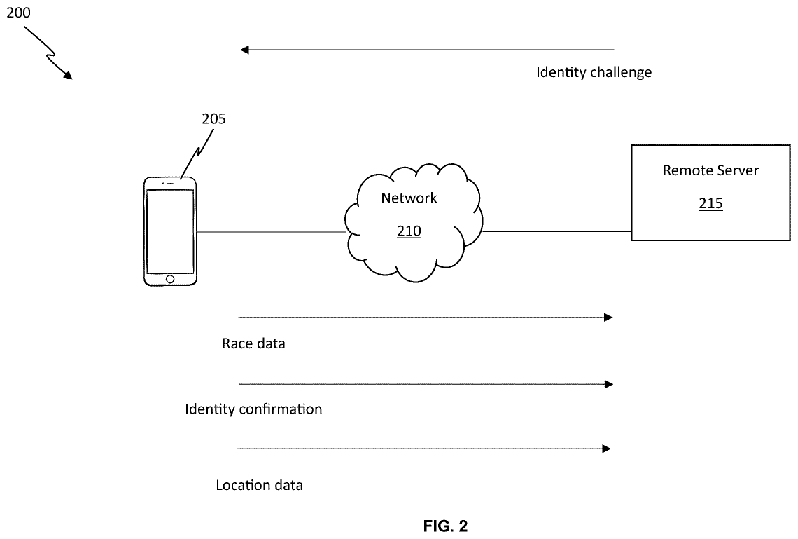

FIG. 2 is a data transmission diagram depicting exemplary transmissions 200 over a network between a smartphone and a remote server for initiating a virtual race conducted based on real-world activity according to embodiments of the present invention. A specialized web platform is executed or hosted by a remote server and a dedicated mobile application seamlessly facilitates the efficient organization of hybrid athletic races. Real-time data exchange between the platform and the mobile application during a race ensures a synchronized and immersive experience for participants.

Smartphone 205 is carried or worn by a participant in the virtual race and can be any mobile electronic device suitable for use during athletic competition. The participant performs in the event by running, biking, etc., as if they were competing at the location of the corresponding real-world event, and the participant's speed and position are translated by remote server 215 based on real-world event conditions to determine the runner's position and placement in the remote race. For example, remote server 215 can determine that the remote participant finished with a faster time than another participant based on computed race metrics. The computed position, distance, speed etc. can be displayed on a display of the smartphone in real-time throughout the competition, according to embodiments.

To begin a race, remote server 215 can issue an identity challenge that requests identification information, a code, password, etc., used to confirm the participant's identity over network 210. In response, the participant sends an identity confirmation to remote server 215 over network 210 to confirm their identity, and optionally race and/or location data that confirms the participant's location. For example, the runner can manually select an upcoming or ongoing event to participate in, and can further include which division, bracket, or category of race they intend to participate in. The runner's location can be used to set the runner's starting location and continuously or periodically map their real-world progress to progress in the remote event.

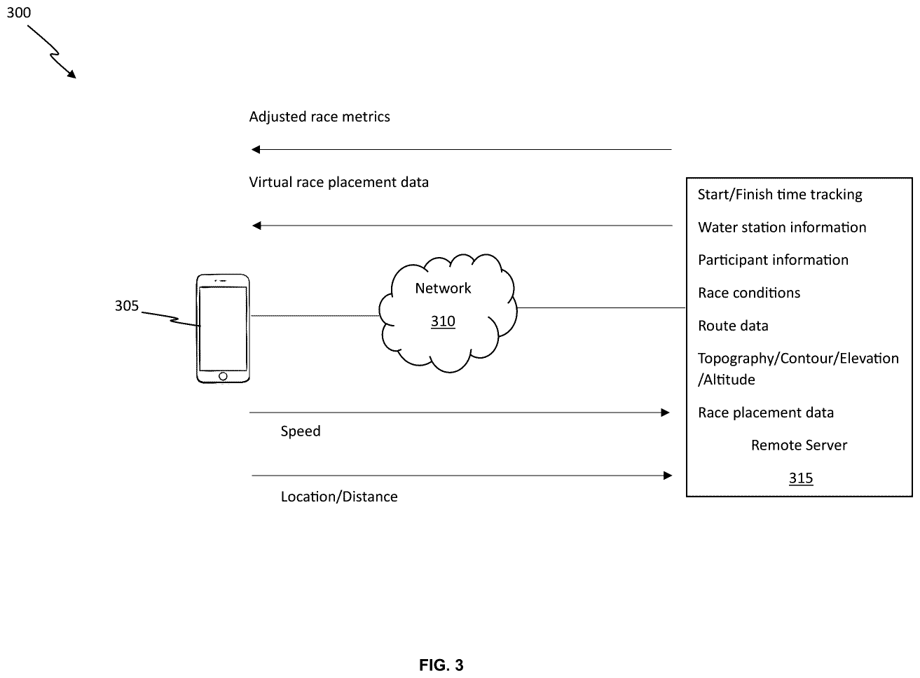

FIG. 3 is a data transmission diagram depicting exemplary transmissions 300 over a network between a smartphone and a remote server over a computer network for adjusting race metrics based on real-world event conditions to determine race position and/or race placement information of a virtual race according to embodiments of the present invention. Smartphone 305 can be worn or carried by a runner during the virtual race and communicates with remote server (e.g., a web platform) 315.

The runner's speed and/or location data can be tracked by smartphone 305 in real-time and transmitted to remote server 315 over network 310. According to some embodiments, the distance and/or route run by the participant are transmitted by smartphone 305 to remote server 315. Remote server 315 can map the real-world data captured by smartphone 305 to corresponding “virtual” race metrics to determine the participant's speed, distance, time, placement, etc., as if they were physically participating at the event location. For example, the distance covered by a runner can be mapped to a greater or smaller distance based on wind speed and direction, temperature, elevation, etc., as determined at the runner's location and/or at the location of the real-world event. The race metrics typically include a timestamp or are transmitted alongside a timestamp or other time information/metadata.

The runner's start time and end time can be recorded by remote server 315, as well as participant information, water station information, race conditions including topography, contour, and elevation data. Remote server 315 can also compute and transmit race placement data to smartphone 305 at the end of a race or throughout the event.

FIG. 4 is a flowchart depicting an exemplary series of computer implemented steps of a process 400 for conducting a remote athletic competition based on real-time conditions of an in-person event, such as a marathon or other race, according to embodiments of the present invention.

At step 405, a new race is initiated by a remote participant. Step 405 can include selecting a race and optionally a race category (e.g., race division or starting group, etc.) and transmitting identity confirmation information in response to an identity challenge. For example, a participant can confirm their identity by enrolling prior to the event and logging in using established credentials or by uploading other identifying information (e.g., a credit card, address, or ID). Step 405 can also include a participant designating another participant to act as their pacer, or entering a desired pace (e.g., speed or completion time).

At step 410, the runner begins the race, and their start time and/or location is automatically recorded. Step 410 can include transmitting the recorded information to a remote server, which can be performed continuously during the race, periodically, or at the completion of the event.

At step 415, the runner's location and/or route run is mapped or translated to a corresponding location/path at the remote athletic competition. For example, if the runner has physically run 2 miles in San Jose, the runner's route is mapped to a route at the location of the event (e.g., Boston) of approximately the same 2-mile distance. The runner's real-world and estimated remote location can be updated and displayed in real-time throughout the competition on a graphical user interface of the participants smartphone.

According to some embodiments, at step 415, the runner's race metrics are measured and adjusted or mapped to race metrics based on real-world event conditions. For example, the race metrics and be adjusted based on weather, topography, and/or elevation information recorded or estimated at the runner's location and/or at the location of the real-world event. The adjusted race metrics can then be used to determine the runner's virtual location in the real-world event, as well as placement information, qualifying information, etc.

At step 420, the end time of the runner is recorded at the completion of the event.

At step 425, the recorded race information/metrics are transmitted to a remote server, and the remote server can use the recorded information to determine placement information by comparing the times with other runners.

FIG. 5 is a flowchart depicting an exemplary series of computer implemented steps of a process 500 for adjusting raw race metrics based on real-world conditions of an in-person race and displaying computed race position and/or placement information in real-time using a split screen graphical user interface according to embodiments of the present invention. Participants enjoy an enriched racing experience through the simultaneous visualization of their physical and virtual positions using one or multiple displays, fostering a heightened sense of engagement and immersion.

Process 500 can be used for any number of athletes to participate in global hybrid races from their physical locations, expanding the reach and inclusivity of athletic competitions. Real-time tracking of participants' progress in both physical and virtual environments enhances the competitive aspect of races and can offer instant performance feedback and analysis. Process 500 can be applied to a diverse range of athletic activities, including runs, walks, and cycling competitions, catering to a broad spectrum of user interests and preferences. The remote aspect of the competition eliminates the need for physical travel to participate in races and reduces logistical challenges and associated costs for athletes.

At step 505, a runner's speed, location, number of steps, and/or distance are measured by a smartphone carried or worn by the runner during participation in a virtual race or other athletic competition and can be stored on the smartphone. Step 505 can include the smartphone accessing data of a piece of athletic equipment connected to the smartphone, including a treadmill, exercise bike, etc., connected to the smartphone wirelessly (e.g., Wi-Fi-, Bluetooth, etc.) or over a wired (e.g., USB) connection.

At step 510, the measured data is transmitted by the smartphone to a remote server.

At step 515, the runner's route and/or current location in the real-world is mapped to a corresponding route or location at the remote athletic competition. According to some embodiments, the distance covered by the actual route run and the estimated remote route are of substantially the same length/distance.

According to some embodiments, the measured data received from the smartphone is adjusted by the remote server based on real-world conditions. For example, the real-world conditions of the runner's physical environment can be measured by the smartphone and the conditions at the location of the actual event can be accessed by or provided by the remote server. According to some embodiments, the real-world conditions of the runner's physical environment are estimated or accessed from third-party sources, such as a third-party map or weather data service provider. Adjusting the race metrics can include adjusting the runner's speed, distance covered, location, placement, etc. based on the real-world conditions at the runner's location and/or at the location of the actual event.

At step 520, the smartphone receives the estimated remote route/location from the remote server. Step 520 can also include receiving placement information (e.g., 1^{st} place, 2^{nd} place, etc.) from the remote server.

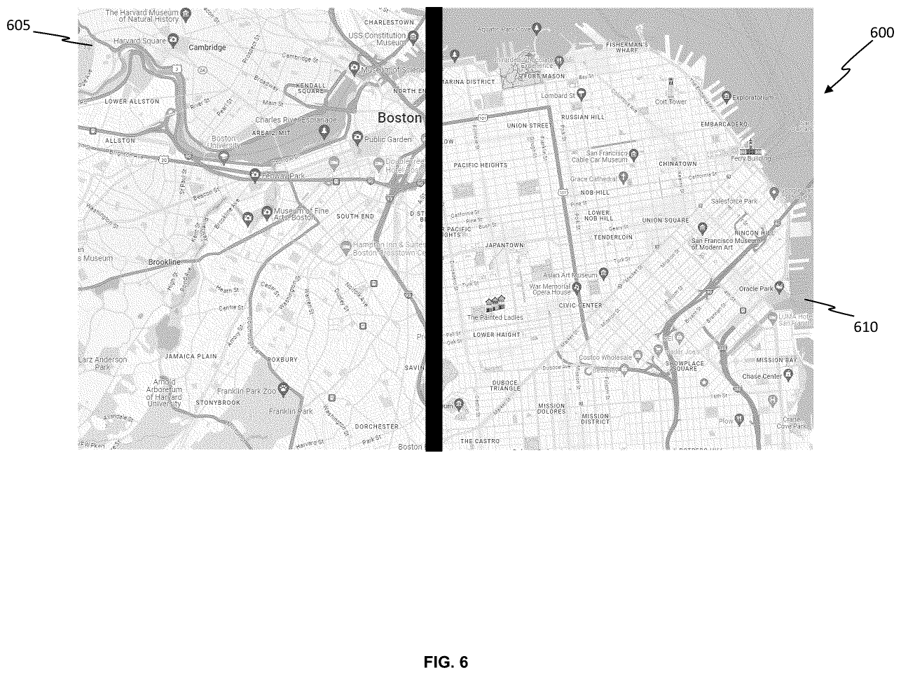

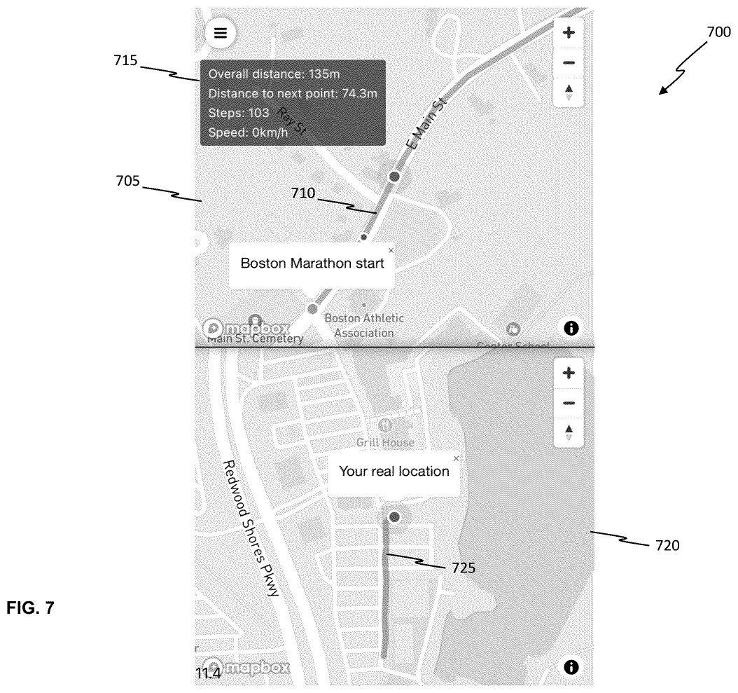

At step 525, the smartphone displays the runner's race progress (e.g., distance, path, speed, etc.) on a local map of the runner's actual location (e.g., San Francisco) while also displaying the runner's computed or estimated progress in the remote athletic event on a map of the remote location (e.g., Boston). The maps can be displayed simultaneously in a split-screen configuration and updated in real-time as depicted in FIGS. 6-7 below according to embodiments. Step 525 can also include displaying the location (real or estimated) of another participant, such as a teammate, competitor, pacer, coach, etc.

FIG. 6 is a screenshot of a split-screen graphical user interface 600 for displaying the computed location of a runner competing in a virtual race alongside the real-world location of the runner according to embodiments of the present invention. Utilizing multiples screens concurrently provides an immersive visualization experience, creating a realistic representation of racers in both physical and virtual environments.

In the example of FIG. 6, horizontal split-screen interface 600 is displayed by a smartphone or other mobile electronic device (e.g., a wearable electronic device). The left side of interface 600 displays a real-time map 605 of a remote athletic event, such as a marathon, cycling event, rowing competition, or any similar type of athletic competition. Ther right side of interface 600 displays a real-time map 610 of the participant's real-world location. The participant's estimated location at the remote athletic event displayed on real-time map 605 can be adjusted based on topography data, weather conditions, etc., according to some embodiments.

FIG. 7 is a screenshot of a split-screen graphical user interface 700 for displaying the computed path and position of a runner competing in a virtual race alongside the real-world path and position of the runner according to embodiments of the present invention. In the example of FIG. 7, race metrics 715 are computed and displayed in real-time on map 705 showing the location of the remote athletic event (e.g., Boston), including the overall distance covered by the participant during the event, the distance to the next point in the race (e.g., the end of the race or the next checkpoint), the total number of steps taken, and the participant's current speed.

The runner's real-world position is displayed on map 720, including the runner's actual path 725. As described in more detail above, the runner's actual path 725 is mapped in real-time to estimated path 710 at the location of the remote event displayed on map 705. The computed path 710 can be based on the distance covered, number of steps, speed, etc., and can be adjusted based on weather, topography, and other real-world conditions.

While the example of FIG. 7 shows a vertical split-screen orientation, additional maps/screens can be displayed simultaneously in any arrangement (e.g., horizontal, vertical, tiled, etc.).

According to some embodiments, GUI 700 includes advertisements displayed to the participants during an event. For example, banner ads can be displayed to the participants during the course of the event, or local business can be highlighted along the route.

According to some embodiments, GUI 700 is displayed on an external display device, such as a TV or other monitor. The external display device can be a local device or a remote device located anywhere in the world that is connected to the Internet. The TV or remote monitor can be configured to display both maps 705 and 720 at the same time.

According to some embodiments, GUI 700 can be configured to display runner information to control a virtual game, such as virtual tag where the runners have to catch each other to become “it” based on location data, or a race to the moon, where GUI 700 shows runner progress during a race to the moon, or across the equator, or any other long-distance location.

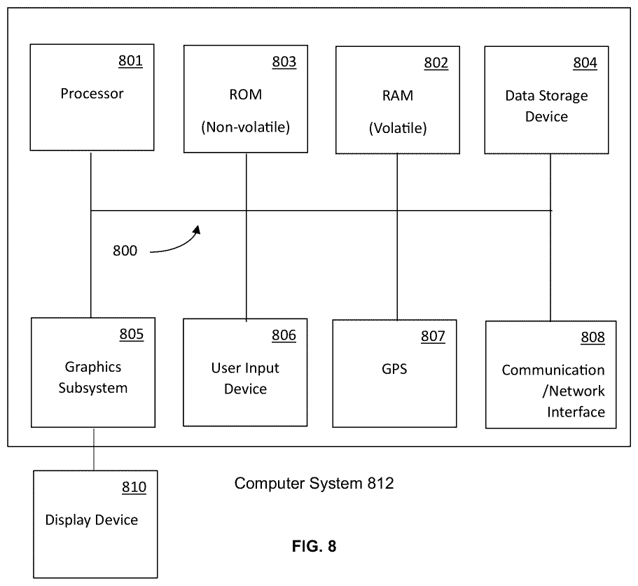

FIG. 8 depicts an exemplary computer system (e.g., smartphone) 812 for capturing race metrics and displaying a runner's position and/or placement in a virtual race using a split screen graphical user interface according to embodiments of the present invention.

In the example of FIG. 8, the exemplary computer system 812 includes a central processing unit (CPU) 801 for running software applications and optionally an operating system. Computer 812 can be a personal computer or a node of a multiprocessor system for example. Random access memory 802 and read-only memory 803 store applications and data for use by the CPU 801. Data storage device 804 provides non-volatile storage for applications and data and may include fixed disk drives, removable disk drives, flash memory devices, and CD-ROM, DVD-ROM or other optical storage devices. The optional user input device 806 comprises devices that communicate inputs from one or more users to the computer system 812 (e.g., mice, joysticks, cameras, touch screens, and/or microphones). Some embodiments of the present invention can use a simplified version of computer system 812 such as an RFID tag, NFC device, Apple AirTag, etc., that can be used to wirelessly track and transmit location information.

A communication or network interface 808 allows the computer system 812 to communicate with other computer systems, devices, (e.g., exercise equipment), networks, or devices via an electronic communications network, including wired and/or wireless communication and including an Intranet or the Internet. The display device 810 (optional) may be any device capable of displaying visual information in response to a signal from the computer system 812. The components of the computer system 812, including the CPU 801, memory 802/803, data storage 804, user input devices 806, and graphics subsystem 805 may be coupled via one or more data buses 800.

Embodiments of the present invention are thus described. While the present invention has been described in particular embodiments, it should be appreciated that the present invention should not be construed as limited by such embodiments, but rather construed according to the following claims.

What is claimed is:

1. A wireless device for conducting a remote athletic competition, the wireless device comprising:
a processor;
a display device communicatively coupled to the processor and operable to render a split-screen graphical user interface (GUI);
a wireless communication interface communicatively coupled to the processor operable to communicate with a remote server; and
a location sensor communicatively coupled to the processor, wherein the location sensor is operable to determine current location data of a remote participant of the remote athletic competition, wherein the processor is operable to determine an estimated position corresponding to the remote athletic competition based on the current location data, and wherein the current location data of a remote participant and the estimated position corresponding to the remote athletic competition are both displayed on the split screen GUI.

2. The wireless device of claim 1, wherein the split-screen GUI comprises:
a first region that displays a map of the remote participant's actual location; and
a second region that displays a map of the remote athletic competition.

3. The wireless device of claim 2, wherein the map of the remote participant's actual location comprises a path physically traversed by the remote participant.

4. The wireless device of claim 3, wherein the map of the remote athletic competition comprises an estimated path traversed by the remote participant.

5. The wireless device of claim 4, wherein the estimated path traversed by the remote participant is computed by the processor based on at least one of: a number of steps taken by the remote participant; the distance traversed by the remote participant; and the speed of the remote participant.

6. The wireless device of claim 4, wherein the first region and the second region are displayed side-by-side in a horizontal configuration.

7. The wireless device of claim 4, wherein the first region and the second region are displayed in a vertical configuration.

8. The wireless device of claim 1, wherein the split-screen GUI is operable to display a location of a pacer.

9. The wireless device of claim 1, wherein the processor is operable to adjust the estimated position corresponding to the remote athletic competition based on at least one of: weather data; and topography data.

10. A method of conducting a remote athletic competition in real-time based on a remote athletic competition, the method comprising:
determining a runner's real-world location;
transmitting the runner's real-world location to a remote server;
the remote server translating the runner's real-world location to an estimated location corresponding to a remote athletic competition;
receiving the estimated location from the remote server; and
displaying the runner's real-world location and the estimated location in real-time on a split-screen graphical user interface (GUI).

11. The method of claim 10, wherein the runner's real-world location and the estimated location are continuously updated during the remote athletic competition.

12. The method of claim 10, further comprising displaying race metrics of the runner on the split-screen GUI, wherein the race metrics comprise at least one of: overall distance; distance to next checkpoint; steps; and speed.

13. The method of claim 10, further comprising displaying pace information on the split-screen GUI.

14. The method of claim 10, further comprising:
selecting another participant as a pacer; and
displaying the location of the pacer on the split-screen GUI.

15. A method of conducting a remote athletic competition in real-time based on a real-world athletic competition, the method comprising:
verifying an identity of a remote participant;
recording a start time of the remote athletic competition, wherein the start time of the remote athletic competition is substantially equal to a start time of the real-world athletic competition;
mapping a location of the remote participant to an estimated location at the location of the remote athletic competition; and
displaying the location of the remote participant and the estimated location at the location of the remote athletic competition simultaneously and in real-time using a split-screen graphical user interface (GUI).

16. The method of claim 15, further comprising accessing real-world athletic competition data.

17. The method of claim 16, further comprising determining placement information of the remote participant based on the real-world athletic competition data.

18. The method of claim 15, further comprising:
the remote participant selecting another participant as a pacer; and
displaying the location of the another participant on the split-screen GUI.

19. The method of claim 15, further comprising:
the remote participant selecting a pace time value; and
displaying a pace location on the split-screen GUI based on the pace time value.

20. The method of claim 15, further comprising displaying race metrics of the remote participant on the split-screen GUI, wherein the race metrics comprise at least one of: overall distance; distance to next checkpoint; steps; and speed.
